(19) United States
(12) Patent Application Publication
(10) Pub. No.: US 2006/0212442 A1
(43) Pub. Date: Sep. 21, 2006

(54) Methods of Presenting and Providing Content to a User

(75) Inventors: Thomas J. Conrad, Oakland, CA (US); Daniel B. Lythcott-Haims, Palo Alto, CA (US); Neil E. Mix, Appleton, WI (US); Joseph J. Kennedy, Danville, CA (US); Etienne F. Handman, Dublin, CA (US); Timothy B. Westergren, San Francisco, CA (US)

Correspondence Address: BANNER & WITCOFF, LTD., TEN SOUTH WACKER DRIVE, SUITE 3000, CHICAGO, IL, 60606, US

(73) Assignee: Pandora Media, Inc., Oakland, CA (US)

(21) Appl. No.: 11/279,567

(22) Filed: Apr. 13, 2006

Related U.S. Application Data
(63) Continuation-in-part of application No. 11/295,339, filed on Dec. 6, 2005.
Application No. 11/295,339 is a continuation-in-part of application No. 10/150,876, filed on May 16, 2002, now Pat. No. 7,003,515.
(60) Provisional application No. 60/291,821, filed on May 16, 2001.

(51) Int. Cl. G06F 17/30; G06F 7/00

(52) U.S. Cl. 707/5

(57) ABSTRACT

Methods of presenting and providing content to a user are disclosed. For example, a user may provide an input seed such as a song name or artist name. The input seed is compared to database items and a playlist is generated as a result. The playlist has an identifier corresponding to one of the database items. A first graphic element associated with the input seed is displayed. A second graphic element associated with the identifier is displayed. As another example, a plurality of database items are compared and a playlist is generated as a result. The playlist has a first identifier corresponding to a first database item. A first graphic element associated with the first identifier is displayed. A first content object corresponding to the first identifier is provided to the user.

This application is a continuation-in-part of U.S. patent application Ser. No. 11/295,339, filed Dec. 6, 2005, which is a continuation-in-part of U.S. patent application Ser. No. 10/150,876, filed May 16, 2002, now U.S. Pat. No. 7,003,515. This application also claims priority to provisional U.S. Patent Application Ser. No. 60/291,821, filed May 16, 2001. The entire disclosures of U.S. patent application Ser. Nos. 11/295,339, 10/150,876 and 60/291,821 are hereby incorporated by reference.

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE EMBODIMENTS OF THE INVENTION

Embodiments of the invention are directed to methods and systems for presenting and providing content to a user.

### BACKGROUND OF THE EMBODIMENTS OF THE INVENTION

Graphical user interfaces are widely used to enhance the functionality and user-friendliness of software programs and hardware devices. The “MAC OS” operating system from Apple Computer Corp. and “WINDOWS” operating system from Microsoft Corp. are well-known examples of graphical user interface-based operating systems for personal computers. ATM machines, cellular telephones and televisions are examples of other devices that use graphical user interfaces.

Recently, personal audio devices such as the “iPod” by Apple Computer Corp. have become popular. These devices use graphical user interfaces to enable users to readily navigate and play songs stored in the devices. Software programs such as “MORPHEUS” from StreamCast Networks, Inc. and “iTunes” from Apple Computer Corp. use graphical user interfaces to facilitate the searching and purchasing of songs for download to personal audio devices, or to facilitate the ready navigation and playing of songs through computers running those software programs.

Online radio stations that feature streaming music have also recently become popular. U.S. Pat. App. Pub. No. 2002/0082901 describes the use of a graphical user interface in connection with an online radio station. The graphical user interface enables the user to, among other things, modify radio station preferences.

Most recently, Pandora Media Inc. created the “PANDORA”™ music discovery service. Music discovery services such as “PANDORA” are designed to help users find music they will enjoy. Using input provided by a user (such as an artist or song name) and other information, the “PANDORA” music discovery service creates an online radio station that plays songs that are musically similar to the provided information. The customizability and adaptability of the “PANDORA” music discovery service are two of many qualities that distinguish it from online radio stations and other music services.

The technology underlying a music discovery service like “PANDORA” is unique and complex. Existing systems and methods for presenting and providing music to users, such as existing graphical user interfaces, are unable to fully harness the capabilities of the music discovery service. In addition, existing systems and methods for presenting and providing music to users often lack full interactive and user-friendly features that are needed by a music discovery service like “PANDORA.” Accordingly, there exists a need in the art for systems and methods that present and provide content to a user in a manner that is more enabling and engaging for users.

### BRIEF SUMMARY OF EMBODIMENTS OF THE INVENTION

One example of a music discovery service is “PANDORA.” The “PANDORA” music discovery service is powered by the “MUSIC GENOME PROJECT®,” which is a database that captures the results of human analysis of individual songs. The collected data in the database represents measurements of discrete musicological and other characteristics (e.g., “genes” in the Music Genome Project) that defy mechanical measurement. Furthermore, a matching algorithm has been created that can be used to locate one or more songs that sound alike (e.g., are closely related to a source song or group of songs based on their characteristics and weighted comparisons of these characteristics).

In addition, specific combinations of characteristics (or even a single notable characteristic) have been identified that represent significantly discernable attributes of a song. These combinations are known as “focus traits.” For example, prominence of electric guitar distortion, a four-beat meter, emphasis on a backbeat, and a “I, IV, V” cord progression may be a focus trait because such a combination of characteristics is significantly discernable to a listener. Through analysis by human musicologists, a large number of focus traits have been identified-each based on a specific combination of characteristics.

The “PANDORA” music discovery service takes an input seed provided by a user (such as an artist or song name) and feedback (e.g., “I like this,” “I don't like this”) and uses the “MUSIC GENOME PROJECT” to create online radio stations that play songs that are musically similar to the provided information.

Embodiments of the invention are directed to systems and methods for presenting and providing content to one or more users. For example, one embodiment of the invention includes the steps of enabling a user to selectively provide an input seed corresponding to one or more database items; generating a playlist as a result of a comparison between the input seed and a plurality of database items, the playlist having an identifier corresponding to one of the plurality of database items; associating a first graphic element with the input seed; representing the first graphic element on a display; associating a second graphic element with the identifier; and representing the second graphic element on the display.

Another embodiment of the invention includes the steps of generating a playlist as a result of a comparison of a plurality of database items, the playlist having a first identifier corresponding to a first database item and a second identifier corresponding to a second database item; associating a first graphic element with the first identifier; representing the first graphic element on a display; and providing to the user a first content object corresponding to the first identifier. Yet another embodiment of the invention includes the additional steps of associating a second graphic element with the second identifier; representing the second graphic element on the display; and providing to the user a second content object corresponding to the second identifier.

Further embodiments of the invention may include numerous other features and advantages. For example, further embodiments may compromise the additional step of enabling the user to selectively provide the playlist to another user, selectively purchase the content object or selectively provide feedback about the content object. In other embodiments of the invention, computer-executable instructions for implementing the disclosed methods are stored as control logic or computer-readable instructions on computer-readable media, such as an optical or magnetic disk.

Other details features and advantages of embodiments of the invention will become apparent with reference to the following detailed description and the figures.

### BRIEF DESCRIPTION OF THE DRAWINGS

FIG. 1 depicts an exemplary operating environment for an embodiment of the invention;

FIGS. 2a and 2b depict terminal-based displays for presenting and providing content to a user in accordance with embodiments of the invention;

FIGS. 3a-3d depict in more detail the graphical user interface of FIGS. 2a and 2b in various stages of operation and in accordance with an embodiment of the invention;

FIG. 4 depicts, in accordance with an embodiment of the invention, a station pop-up menu generated in response to a user selecting a button such as “Station 1” button 308 in FIG. 3c.

FIG. 5 depicts, in accordance with an embodiment of the invention, the graphical user interface of FIGS. 2a and 2b after a user has clicked the “Add More Music” menu choice 402 of station pop-up menu 400 in FIG. 4;

FIG. 6 depicts, in accordance with an embodiment of the invention, the graphical user interface of FIGS. 2a and 2b after a user has clicked the “Email This Station” menu choice 404 of station pop-up menu 400 in FIG. 4;

FIGS. 7a-c depict, in accordance with an embodiment of the invention, the graphical user interface of FIGS. 2a and 2b in various stages of operation after a user has clicked the “Edit This Station” menu choice 406 of station pop-up menu 400 in FIG. 4;

FIG. 8 depicts, in accordance with an embodiment of the invention, a content pop-up menu generated in response to a user selecting a component of a graphical element, such as content art 332 of second graphic element 326.

FIG. 9 depicts, in accordance with an embodiment of the invention, an “Information” panel 900 that appears on graphical user interface 208 after the user has selected, for example, “Why Did You Play This Song” menu choice 802.

FIG. 10 depicts, in accordance with an embodiment of the invention, a “Create New Station” panel 1000 that appears on graphical user interface 208 after the user has selected, for example, “Make a New Station from This Song” menu choice 804.

FIG. 11 depicts a “Favorites” display 1100 in accordance with an embodiment of the invention.

FIG. 12 depicts a flow diagram overview of methods for presenting and providing content to a user.

FIG. 13 depicts a relationship between different song candidates.

FIG. 14 is a graph showing a deviation vector.

FIG. 15 graphically depicts a bimodal song group.

FIG. 16 shows a flow diagram for one or more embodiments of the “Generate or Modify Playlist” step 1204 in FIG. 12.

FIG. 17 shows a flow diagram for one or more embodiments of the “Identify Characteristics” step 1604 in FIG. 16.

### DETAILED DESCRIPTION OF EMBODIMENTS OF THE INVENTION

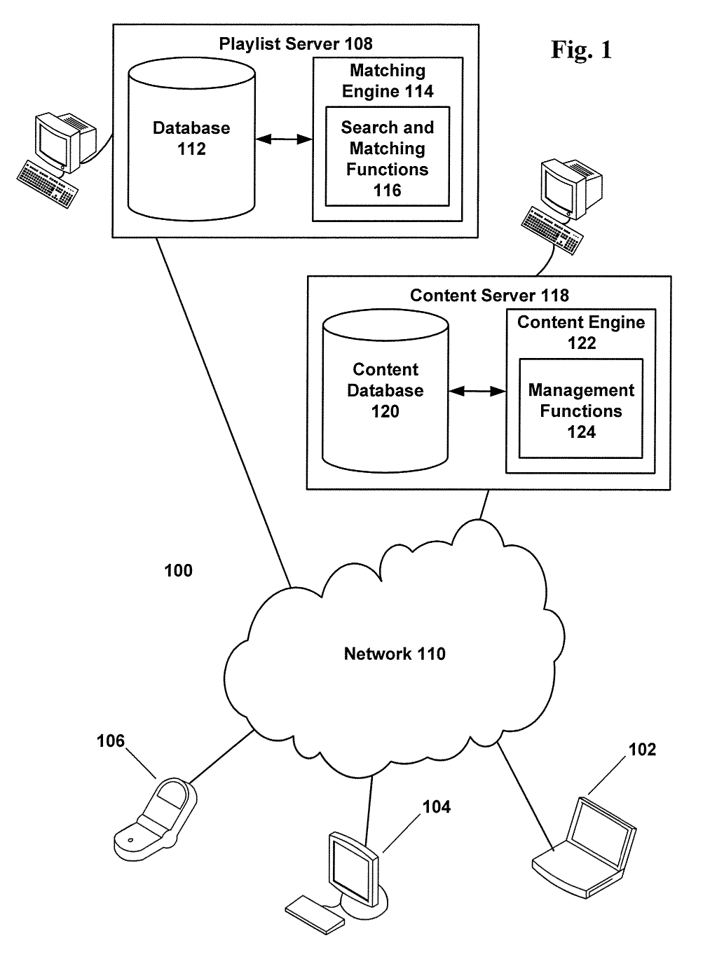

FIG. 1 depicts a diagram of exemplary system 100 that may be used to implement embodiments of the invention. A plurality of terminals, such as terminals 102, 104 and 106, couple to playlist server 108 and content server 118 via network 110. In another embodiment, playlist server 108 and content server 118 may be the same server performing all functions of playlist server 108 and content server 118. Terminals 102, 104 and 106, playlist server 108 and content server 118, may include a processor, memory and other conventional electronic components and may be programmed with processor-executable instructions to facilitate communication via network 110 and perform aspects of the invention.

One skilled in the art will appreciate that network 110 is not limited to a particular type of network. For example, network 110 may feature one or more wide area networks (WANs), such as the Internet. Network 110 may also feature one or more local area networks (LANs) having one or more of the well-known LAN topologies and the use of a variety of different protocols on these topologies, such as Ethernet, TCP/IP, Frame Relay, Ethernet, FTP, HTTP and the like, is presumed. Moreover, network 110 may feature a Public Switched Telephone Network (PSTN) featuring land-line and cellular telephone terminals, or else a network featuring a combination of any or all of the above. Terminals 102, 104 and 106 may be coupled to network 110 via, for example, twisted pair wires, coaxial cable, fiber optics, electromagnetic waves or other media.

In one embodiment of the invention, playlist server 108 contains a database of items 112. Alternatively, playlist server 108 may be coupled to database of items 112. For example, playlist server 108 may be coupled to a “MUSIC GENOME PROJECT” database as described in U.S. Pat. No. 7,003,515. Playlist server 108 may also contain or be coupled to matching engine 114. Matching engine 114 utilizes an associated set of search and matching functions 116 to operate on the database of items 112. In an embodiment of the invention used with the “MUSIC GENOME PROJECT” database, for example, matching engine 114 utilizes search and matching functions implemented in software or hardware to effectively calculate the distance between a source song and other songs in the database (as described here and in U.S. Pat. No. 7,003,515), and then sorts the results to yield an adjustable number of closest matches.

In one embodiment of the invention, content server 118 contains a database of content objects 120. Alternatively, content server 118 may be wholly or partially integrated with playlist server 108, or separately coupled to a database of content objects 120. Content server 118 may also contain or be coupled to content engine 122. Content engine 122 utilizes an associated set of management functions 124, such as standard finding, packaging and sending functions, to operate on the database of content objects 122. In one embodiment of the invention, for example, content engine 122 utilizes management functions implemented in software or hardware to control the transmission of content objects by, for example, streaming and/or downloading to terminals 102, 104 and 106.

Terminals 102, 104 and 106 feature user interfaces that enable users to interact with server 108. The user interfaces may allow users to utilize a variety of functions, such as displaying information from playlist server 108, requesting additional information from playlist server 108, customizing local and/or remote aspects of the system and controlling local and/or remote aspects of the system. Terminals 102, 104 and 106 can be operated in a client-server configuration to permit a user to retrieve web pages from playlist server 108. Furthermore, any of various conventional web browsers can be used to display and manipulate data on the web pages.

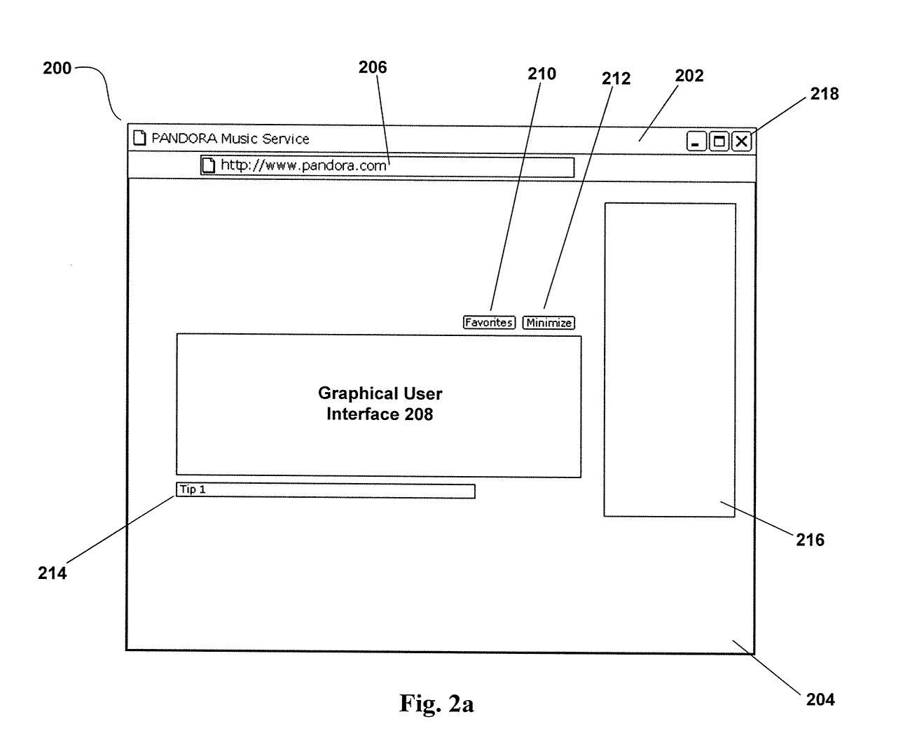

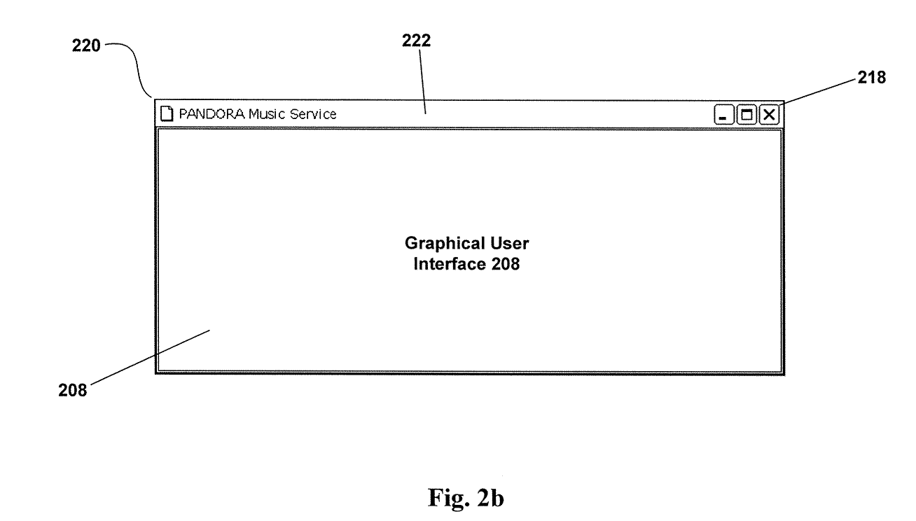

FIG. 2a depicts terminal-based display 200 for presenting and providing content to a user in accordance with an embodiment of the invention. Terminal-based display 200 may comprise, for example, a web browser window 204 displayed on terminal 102 (FIG. 1) running an operating system such as “WINDOWS” from Microsoft Corp. In this embodiment, terminal 102 is configured as the client in a client/server relationship with playlist server 108 and content server 118.

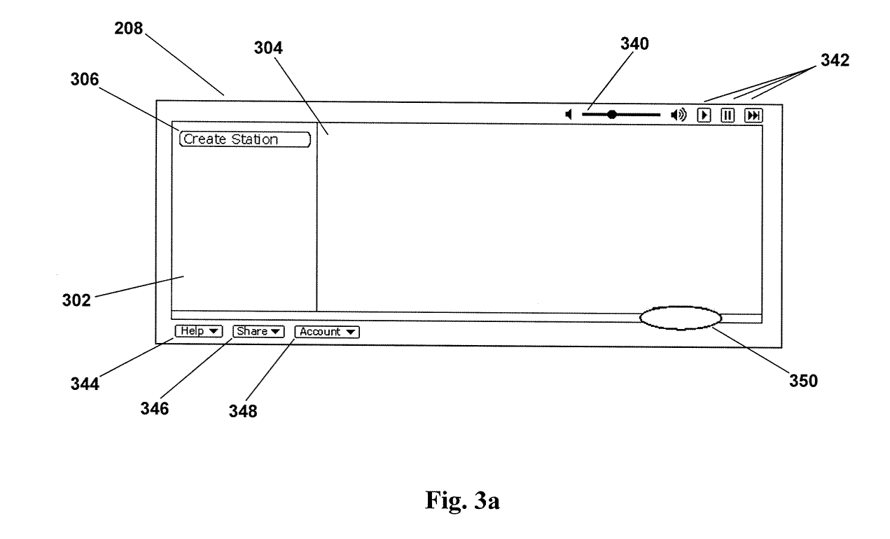

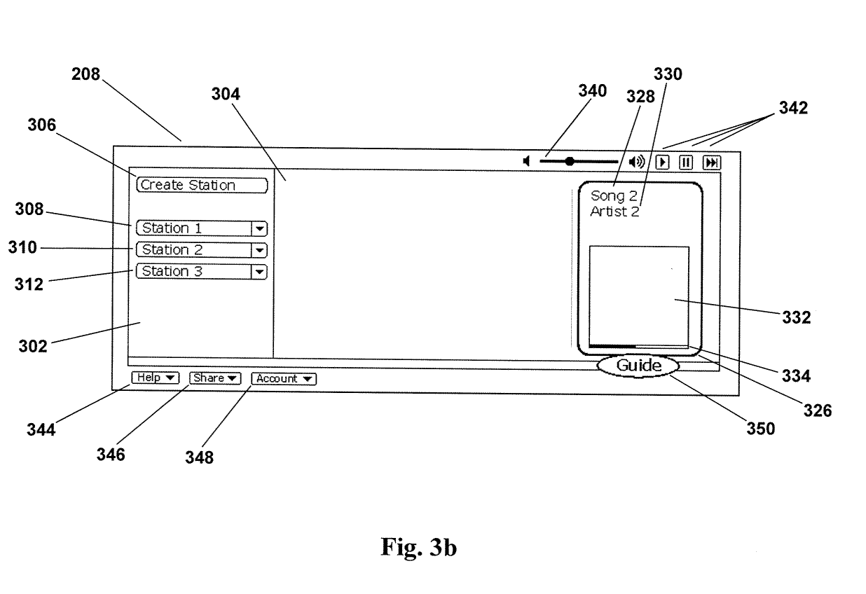

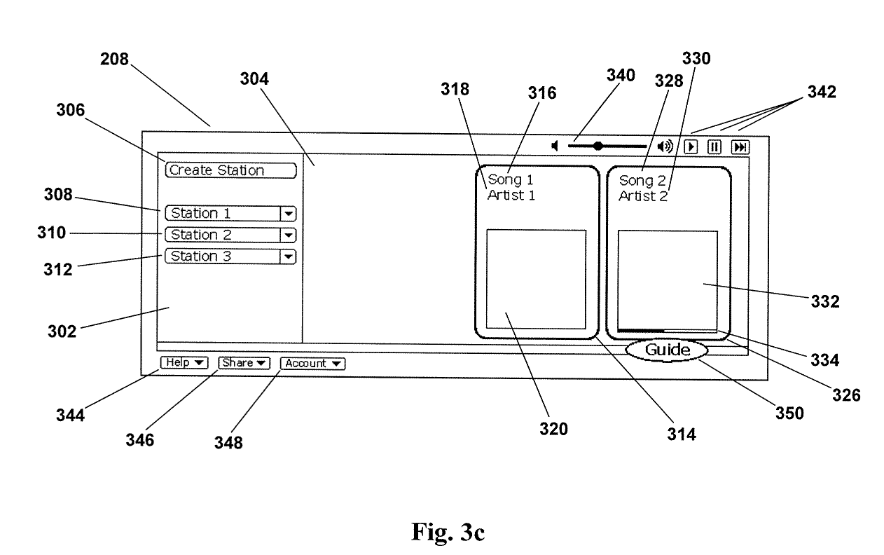

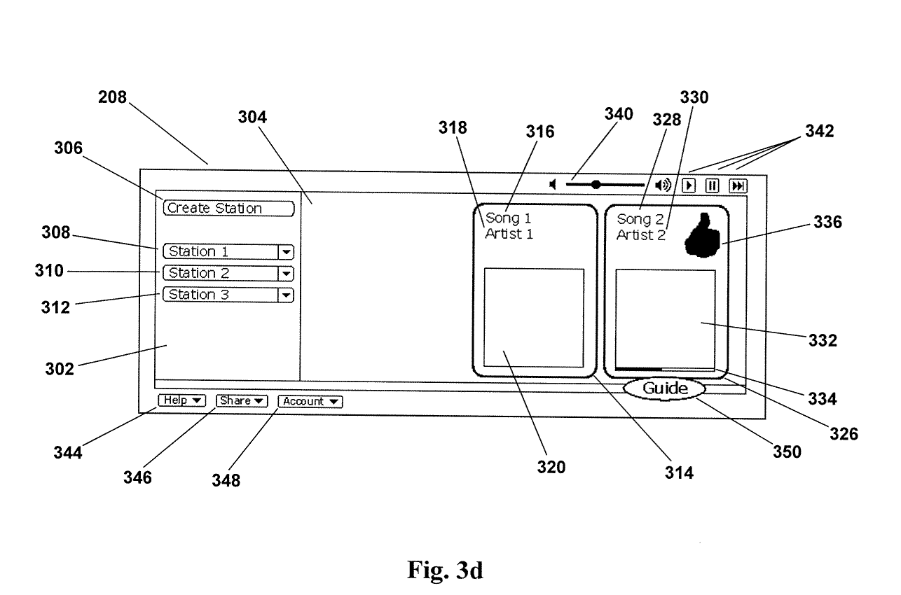

A user of terminal 102 establishes a client/server relationship with playlist server 108 by inputting the appropriate URL in address field 206 (in this case, the URL is “http://www.pandora.com”). In response, web page 204 is retrieved from playlist server 108. In this embodiment, web page 204 features graphical user interface 208 (shown in more detail in, e.g., FIG. 3d), “favorites” button 210, “minimize” button 212, tip 214 and advertisement 216.

In this embodiment, the user's selecting of “minimize” button 212 (such as by clicking a mouse button while the mouse pointer is over “minimize” button 212) removes graphical user interface 208 from web page 204 and results in the creation of terminal-based display 220 shown in FIG. 2b. Terminal-based display 220 presents and provides content to a user in accordance with another embodiment of the invention. Specifically, terminal-based display 220 may comprise, for example, a web browser window 222 featuring graphical user interface 208 without, for example, “favorites” button 210, “minimize” button 212, tip 214 and advertisement 216. Terminal-based display 220 is smaller than terminal-based display 200 and thus better preserves desktop display resources. In a web page replacing web page 204, the user is given the option to return graphical user interface 208 to terminal-based display 200. The user of terminal 102 may discontinue the client/server relationship with playlist server 108 by selecting “close window” button 218. To the extent the user later opens a new web browser window and reestablishes a client/server relationship with playlist server 108, playlist server 108 recognizes the user as a result of well-known schemes such as “cookies” and thus retains any customized user preferences or settings when web page 204 is retrieved and graphical user interface 208 is restarted.

In this embodiment, tip 214 enhances the user-friendliness of graphical user interface 208 by providing information to the user regarding how to use graphical user interface 208. For example, tip 214 may state “Use thumbs up/thumbs down to tune your stations. Click here to learn more.” To the extent the user clicks the hypertext link “Click here,” another web page is retrieved providing more detailed information about how to tune stations. Tip 214 may also advertise career opportunities or display other information. In another embodiment, tip 214 may be provided in connection with terminal-based display 220.

In this embodiment, advertisement 216 may comprise a standard paid “banner” advertisement for a third party in any configuration on web page 204. Advertisement 216 may generate royalty revenue or other income for the operator. In one embodiment, the type of advertisement 216 presented to the user on web page 204 depends on various criteria, including but not limited to input, feedback and other information provided by the user, the location of the user's IP address, and other information such as the time of day or year.

FIGS. 3a-3d depict in more detail graphical user interface 208 (FIGS. 2a and 2b) in various stages of operation and in accordance with an embodiment of the invention. Graphical user interface 208 is provided through playlist server 108 (FIG. 1) and may be implemented through, for example, Java, JavaScript, XML, Flash or HTML.

Turning to FIG. 3c, graphical user interface 208 features station panel 302 and playlist panel 304. Other embodiments may have more or less panels. Station panel 302 features “Create Station” button 306 and “Station 1,” “Station 2” and “Station 3” buttons 308, 310 and 312.

As will be described further below, “Create Station” button 306 initiates the generation of a station (e.g., a station corresponding to “Station 1” button 308) corresponding to an input seed, such as a song name or artist name, selectively provided by the user. The station facilitates the providing of content to the user that, for example, corresponds to a playlist generated as a result of a comparison of the input seed to musicological attributes of other songs. Thus, for example, the user could input “Miles Davis” and a “Miles Davis station” would be created that facilitates the providing of content to the user that corresponds to “Miles Davis” songs or songs that are musicologically similar to songs by “Miles Davis.”

In this embodiment, playlist panel 304 visually represents to the user a playlist of content objects such as songs, the first song of which corresponds to first graphic element 314 and the second song of which corresponds to second graphic element 326. First graphic element features corresponding song text 316, artist text 318 and content art 320, while second graphic element 326 features corresponding song text 328, artist text 330 and content art 332. Corresponding song text 316 and 328, as well as corresponding artist text 318 and 330 may additionally comprise hypertext links that provide additional information, such as background knowledge about an artist or song. Corresponding content art 320 and 332 may comprise, for example, a picture of an album cover.

Other embodiments of first graphic element 314 or second graphic element 326 may feature additional or fewer components than the embodiment that has been described. Other types of components include “purchase” buttons, advertisements, feedback indicators (such as feedback indicator 336 in FIG. 3d) and links to additional services and information. In addition, other embodiments of first graphic element 314 or second graphic element 326 may feature different sizes, shapes and appearances than the embodiment that has been described.

In this embodiment, the song currently being provided to the user is visually represented by the rightmost graphic element (i.e., second graphic element 326). After songs have been provided to the user, or otherwise discarded, the graphic elements corresponding to those songs are scrolled to the left across playlist panel 304 (in this example, approximately three graphic elements total can be visualized to the user). In the embodiment shown in FIG. 3c, first graphic element 314 corresponds to a song that has already been provided to the user, while second graphic element 326 corresponds to a song that is currently being provided to the user. In one embodiment of the invention, the fact that second graphic element 326 is currently being provided to the user is emphasized by tinting, shading or otherwise de-emphasizing first graphic element 314, or highlighting, brightening or otherwise emphasizing second graphic element 326. In addition, playback bar 334 may be featured as a component of second graphic element 326 to indicate how much of the currently provided song has already been played. Of course, other embodiments may feature alternative ways of visually representing the playlist and/or the progression of the playlist, as well as fewer or more graphic elements and alternative ways for representing those graphic elements.

In the embodiment shown in FIG. 3c, graphical user interface 208 also features volume control 340, playback controls 342, “Help” button 344, “Share” button 346, “Account” button 348 and “Guide” button 350. Volume control 340 adjusts the audible volume of content objects having audio that are provided to the user in accordance with embodiments of the invention. Playback controls 342 allow the user to pause or resume the playing of content objects. Playback controls 342 also allow the user to terminate playing of the current content object in favor of another content object.

The user's selecting of “Help” button 344 generates an on-screen pop-up menu providing clickable menu choices that provide additional features to the user and enhance the user-friendliness of graphical user interface 208. For example, the on-screen pop-up menu may include choices providing additional information about a music discovery service, such as a FAQ, contact information or legal notices.

The user's selecting of “Share” button 346 generates another pop-up menu providing clickable menu choices relating to, for example, sharing features of graphical music interface 208. For example, the pop-up menu may include choices for providing a playlist to other users of the music discovery service (e.g., enabling another user to enjoy a station such as the station corresponding to “Station 1” button 308 and thus to be provided content corresponding to that station). The pop-up menu may also include choices for facilitating the providing of content by another station created by another user, the operator or a third party.

The user's selecting of “Account” button 348 generates another pop-up menu providing clickable menu choices relating to, for example, customized user preferences or settings. For example, the pop-up menu may include choices for viewing favorite stations, editing account and contact information or subscribing to the music discovery service. “Subscribing” may mean, for example, that in exchange for an annual fee, the user will no longer see advertisement 216 when using the music discovery service.

In this embodiment, the user's selecting of “Guide” button 350 generates another pop-up menu providing clickable menu choices relating to, for example, enabling the user to selectively provide feedback about a content object such as a song. In one embodiment, “Guide” button 350 serves as the primary interface for the “back-and-forth” conversation between the user and the music discovery service. For example, the pop-up menu may include choices for enabling the user to provide feedback corresponding to comments such as “I really like this song,” “I don't like this song,” or “I'm tired of this song.” This feedback can be used to customize, adapt and/or enhance the initial playlist generated in connection with a station so that it is more attuned to the preferences of the user.

As another example, the pop-up menu generated by selecting “Guide” button 350 may include other feedback options, such as reasons why the user likes or dislikes a certain song. Exemplary reasons that the user may select as reasons why he or she likes the song include “I like the artist,” “I like the song,” “I like the beat,” “I like the instrument being played,” “I like the meaning of the lyrics,” or “I like the genre.” Exemplary reasons that the user may select as reasons why he or she dislikes the song include “I don't like the artist,” “I don't like the vocals,” “I don't like the repetitiveness,” “The music is too ‘mainstream,’” or “The music is too loud.”

In response to feedback provided by the user, the playlist may be modified. Modifications to the playlist are accomplished, for example, by the use of weighing values and scaling functions as described in currently pending U.S. patent application Ser. No. 11/295,339, as will be discussed further below.

In addition, “Guide” button may include other choices that provide the user with information as to why a song is being played (i.e. what musicological attributes, such as characteristics or focus traits, are contained in a song). “Guide” button may also include other choices that enable the user to selectively modify the input seed so that it, and the playlist that is generated as a result of a comparison between the input seed and other songs, reflects additional artists or songs.

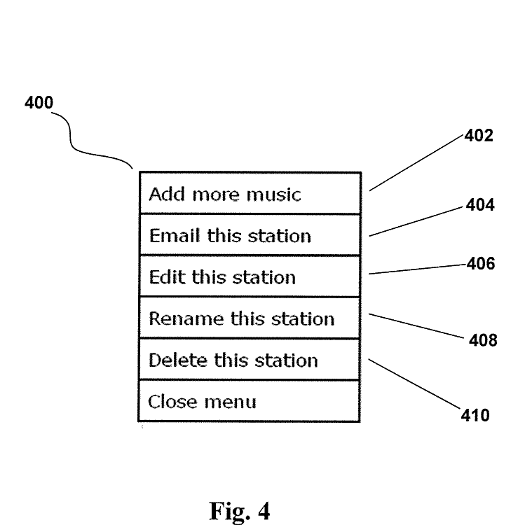

FIG. 4 depicts, in accordance with an embodiment of the invention, station pop-up menu 400, which is generated in response to a user selecting a button such as “Station 1” button 308 in FIG. 3c. Station pop-up menu 400 includes menu choices such as “Add More Music” menu choice 402, “Email This Station” menu choice 404, “Edit This Station” menu choice 406, “Rename This Station” menu choice 408 and “Delete This Station” menu choice 410. Other embodiments of the invention may have fewer, additional or alternative menu choices.

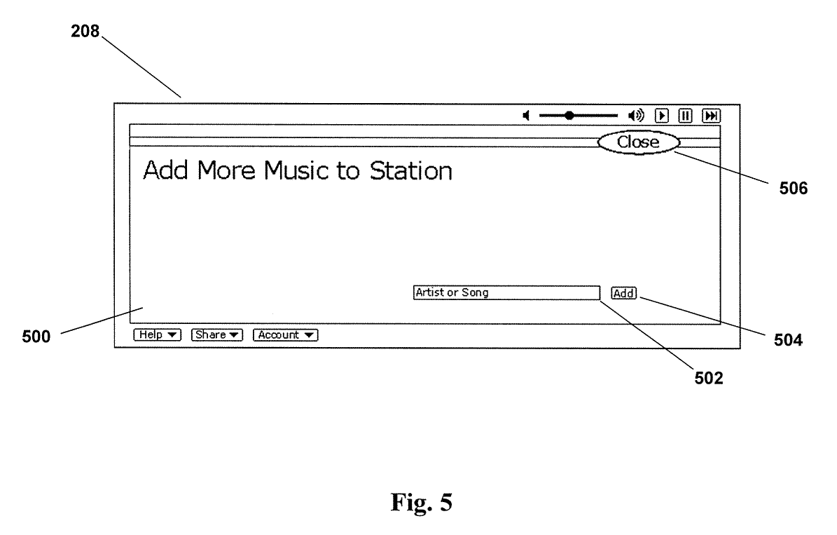

In one embodiment, “Add More Music” menu choice 402 enables the user to selectively modify the input seed corresponding to the current station. FIG. 5 depicts “Add More Music” panel 500 that appears on graphical user interface 208 after the user has selected “Add More Music” menu choice 402. “Add More Music” panel features entry field 502. Entry field 502 enables the user to selectively modify the input seed by entering, for example, another artist name or song name (in addition to the artist name, song name or other input seed previously entered) and then selecting “Add” button 504 (if the user does not desire to selectively modify the input seed, then the user selects “Close” button 506). The additional artist name or song name is then factored into the comparison between the input seed and songs contained in the “MUSIC GENOME PROJECT” database. One way to factor the additional artist name or song name into the comparison is to utilize confidence and weighting factors to assign, for example, more or less weight to the musicological attributes of the additional artist name or song name in view of the initial input seed. After the input seed has been selectively modified, “Add More Music” panel 500 disappears and graphical user interface 208 proceeds to present and provide content corresponding to the modified input seed in accordance with FIGS. 2a and 2b. In doing so, “Station 1” button 308 may appear differently to reflect the modified input seed.

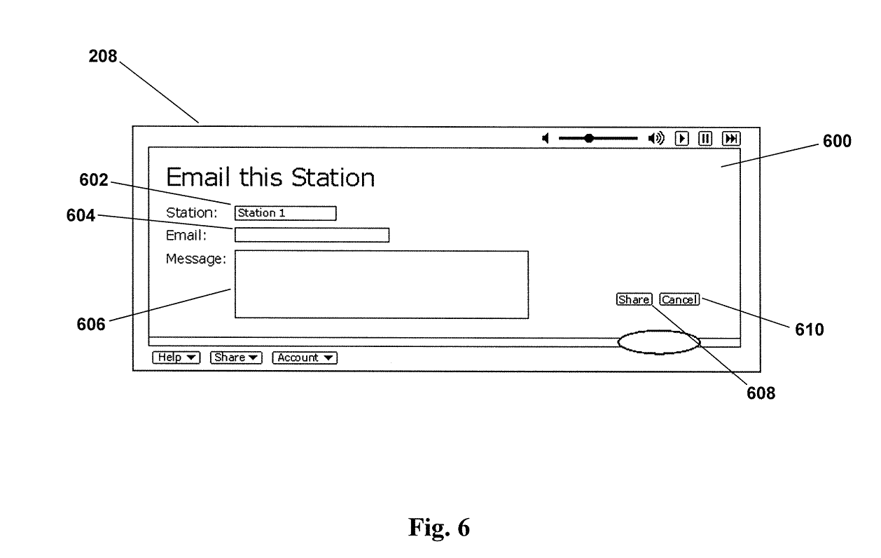

In one embodiment, “Email This Station” menu choice 404 enables the user to selectively provide a station, and thus a playlist, to another user. FIG. 6 depicts “Email This Station” panel 600 that appears on graphical user interface 208 after the user has selected “Email This Station” menu choice 404. “Email This Station” panel 600 features station field 602, email field 604 and message field 606. When selected by the user, station field 602 enables the user to select a station to selectively provide to another user. The stations available to selectively appear on a drop-down menu and may include stations created by the user, such as the station corresponding to “Station 1” button 308 (FIG. 3c), or other stations.

Email field 604 enables the user to enter an email address corresponding to another user for which the user desires to selectively provide a station. Message field 606 enables the user to provide a message (such as regular text or HTML) to the user for which the station has been selectively provided.

After the user has entered information into station field 602, email field 604 and message field 606, the user selects “Share” button 608 to initiate the selective providing of a station to another user. The information is transmitted to playlist server 108 (FIG. 1). Playlist server 108 prepares an email including the information entered in message field 606 to the recipient user utilizing SMTP or other common protocols. The return address of the email corresponds to the email address provided by the user upon registration with the music discovery service. The email further includes a hypertext link to the URL of the music discovery service. The hypertext link includes a command line argument of an identifier corresponding to the station the user desires to selectively provide. If the recipient is already registered with the music discovery service, the station is automatically provided. If the recipient is not registered with the music discovery service, an anonymous registration is created and the hypertext link will direct the recipient to graphical user interface 208 as if the recipient were the anonymous registrant. If the user does not desire to selectively provide a station, and thus a playlist, to another user, then the user selects “Cancel” button 610.

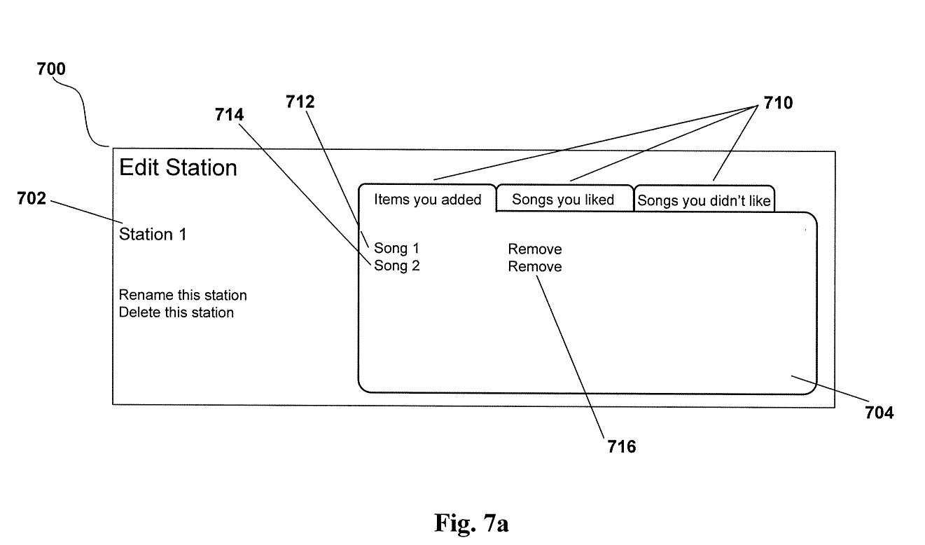

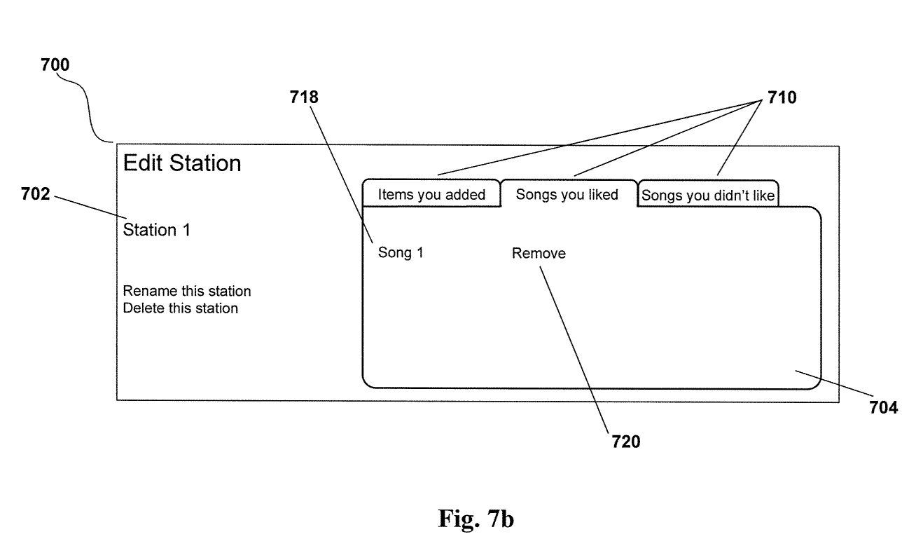

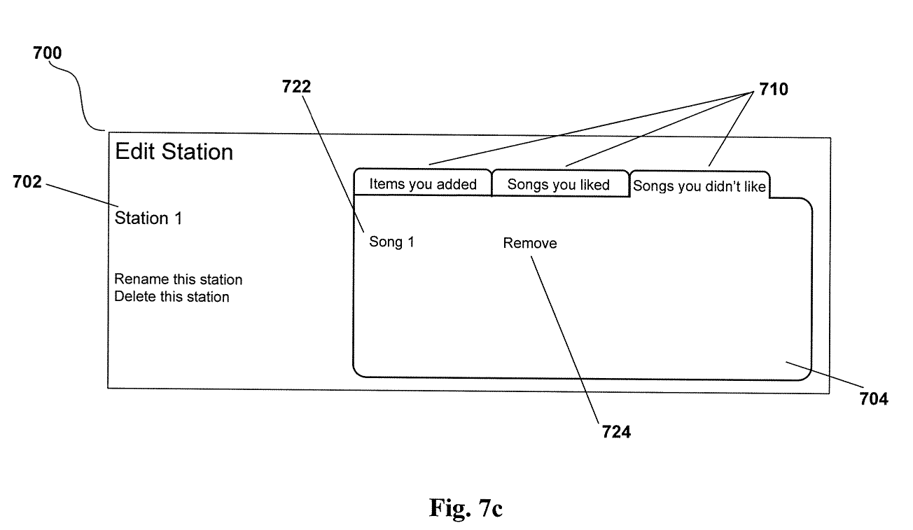

In one embodiment, “Edit This Station” menu choice 406 enables the user to, among other things, selectively modify feedback about a content object such as a song. FIGS. 7a-c depict “Edit This Station” panel 700 that appears after the user has selected “Edit This Station” menu choice 406. Turning to FIG. 7a, “Edit This Station” panel 700 features station title 702, which displays the name of the station (such as the station corresponding to “Station 1” button 308) that is being edited. “Edit This Station” panel 700 also features “Items You Added” panel 704, “Songs You Liked” panel 706 and “Songs You Didn't Like” panel 708. The user may access each of these panels by selecting tab 710 that corresponds to the appropriate panel.

“Items You Added” panel 704 features song name text 712 and/or artist name text 714 corresponding to selective modifications of the input seed corresponding to the current station. Thus, for example, song name text 712 and artist name text 714 respectively correspond to a song and artist previously entered by the user in order to selectively modify the input seed. The user may remove, for example, a song that had previously selectively modified the input seed by selecting “Remove” button 716. Thereafter, graphical user interface 208 will no longer present and provide content corresponding to the modified input seed. Instead, graphical user interface 208 will proceed to present and provide content corresponding to, for example, the initial input seed, or to the input seed as selectively modified by entry of artist 714.

“Songs You Liked” panel 706 features, for example, song name text 718 (or artist name text) corresponding to selective feedback that the user has provided about a song. Thus, for example, song name text 712 corresponds to a song for which the user has previously selectively provided positive feedback. In addition, “Songs You Didn't Like” panel 708 features, for example, song name text 722 (or artist name text) corresponds to a song for which the user has previously selectively provided negative feedback.

The user may delete the feedback previously provided by selecting “Remove” button 720. Thereafter, when the song is provided, graphical user interface 208 will no longer display feedback indicator 336 (FIG. 3d). Multiple songs and/or artists may be listed on “Items You Added” panel 704, “Songs You Liked” panel 706 or “Songs You Didn't Like” panel 708. Moreover, the feedback about the song will no longer be utilized in connection with generating playlists.

As stated previously, in one embodiment, station pop-up menu 400 also features “Rename This Station” menu choice 408 and “Delete This Station” menu choice 410. “Rename This Station” menu choice 408 enables the user to selectively provide an edited name for, for example, the station that corresponds to “Station 1” button 308. “Delete This Station” menu choice 410 enables the user to remove a station from graphical interface 208.

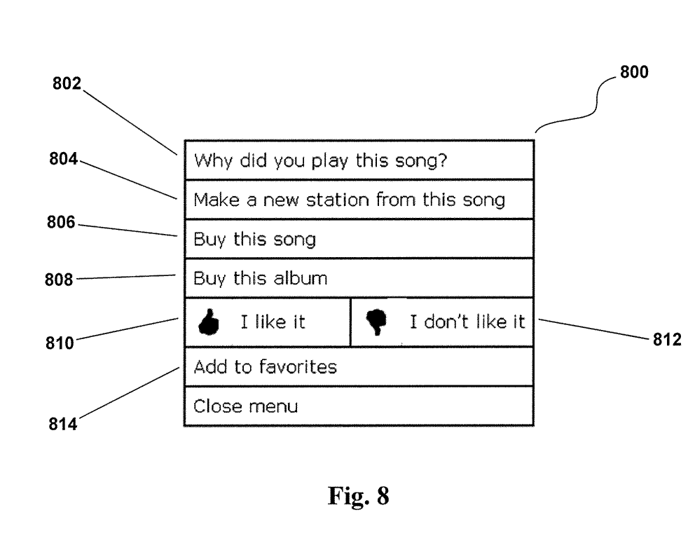

FIG. 8 depicts, in accordance with an embodiment of the invention, content pop-up menu 800, which is generated in response to a user selecting a component of a graphical element, such as content art 332 of second graphic element 326. Content pop-up menu 800 includes menu choices such as “Why Did You Play This Song” menu choice 802, “Make a New Station from This Song” menu choice 804, “Buy This Song” menu choice 806 and “Buy This Album” menu choice 808. Other embodiments of the invention may have fewer, additional or alternative menu choices.

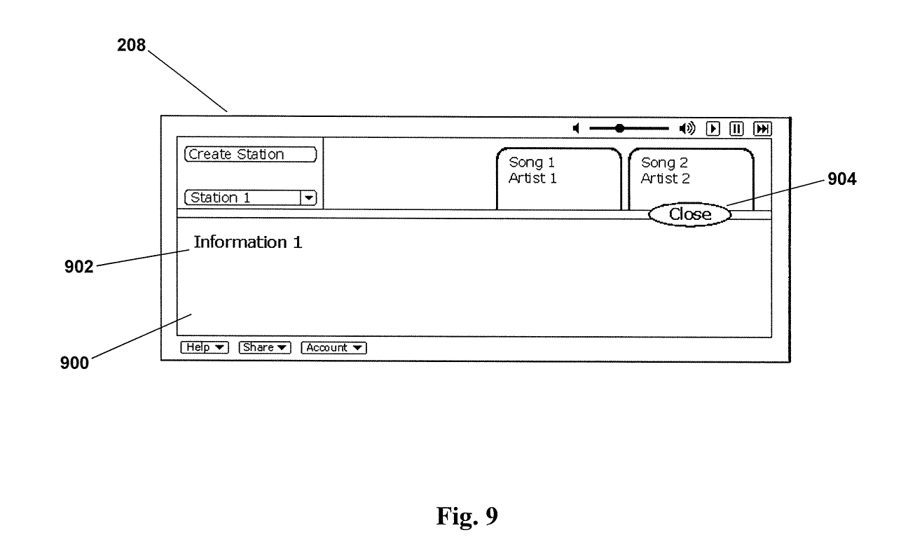

In one embodiment, “Why Did You Play This Song” menu choice 802 initiates the selectively providing of information to the user. FIG. 9 depicts “Information” panel 900 that appears on graphical user interface 208 after the user has selected, for example, “Why Did You Play This Song” menu choice 802. “Information” panel 900 features information, such as information provided in information text 902, about the song or other content object currently being provided to the user. For example, “Information” panel 900 may include information relating to a characteristic or focus trait of the song or other content object. Alternatively, “Information” panel 900 may also include information relating to background knowledge about the song, the artist who created the song or other relevant information. To the extent the user no longer desires to review the information, the user selects “Close” button 904 and information panel 900 disappears.

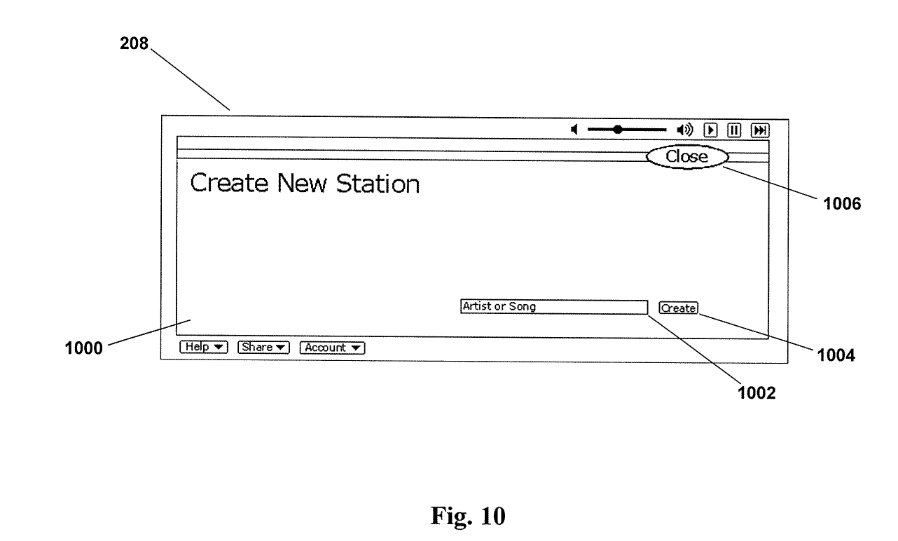

In one embodiment, “Make a New Station from This Song” menu choice 804 facilitates the presenting of content to a user in accordance with the present invention. FIG. 10 depicts “Create New Station” panel 1000 that appears on graphical user interface 208 after the user has selected, for example, “Make a New Station from This Song” menu choice 804. “Create New Station” panel 1000 features input seed field 1002 and “Create” button 1004. In one embodiment of the invention, input seed field 1002 is automatically filled with the song name corresponding to the song that was provided when content pop-up menu 800 was initially selected. In another embodiment, input seed field 1002 is empty and awaits the entry of a song name by the user. To initiate the creation of a new station, the user selects “Create” button 1004 after input seed field 1002 has been filled. In another embodiment, a station is automatically created in graphical user interface 208 after the user has selected “Make a New Station from This Song” menu choice 804. To the extent the user does not desire to create a new station, the user selects “Close” button 1006. “Create New Station” panel 1000 disappears and is replaced on the display by graphical user interface 208.

In one embodiment, content pop-up menu 800 features “Buy This Song” menu choice 806 and “Buy This Album” menu choice 808. If the user selects “Buy This Song” menu choice 806, then the selective purchase of the song (or other content object) is enabled. One way to enable the selective purchase of the song is to hyperlink “Buy This Song” menu choice 806 to a web site such as the “iTunes” web site from Apple Computer Corp. that offers songs for sale. The hyperlink may include a general URL as well as a parameter specifying the exact song for purchase. If the user selects “Buy This Album” menu choice 808, then the selective purchase of the album (or other content object) is enabled. One way to enable the selective purchase of the album is to hyperlink “Buy This Album” menu choice 808 to a web site such as the web site of Amazon.com, which sells albums. The hyperlink may include a general URL as well as a parameter specifying the exact song for purchase.

Content pop-up menu 800 also includes menu choices such as “I Like It” menu choice 810 and “I Don't Like It” menu choice 812. “I Like It” menu choice 810 and “I Don't Like It” menu choice 812 enable the user to selectively provide, respectively, positive or negative feedback about the current song or other content object. If the user selects “I Like It” menu choice 810, then feedback indicator 336 in the shape of, for example, a “thumbs-up” sign is displayed on graphic user interface 208 (FIG. 3d). If the user selects “I Don't Like It” menu choice 812, then feedback indicator 336 in the shape of, for example, a “thumbs-down” sign is displayed on graphic user interface 208 (FIG. 3d). Other types of feedback, such as “Don't play this song for awhile” may also be selectively provided. As stated previously, feedback may be used to customize and enhance playlists and other aspects of the user experience.

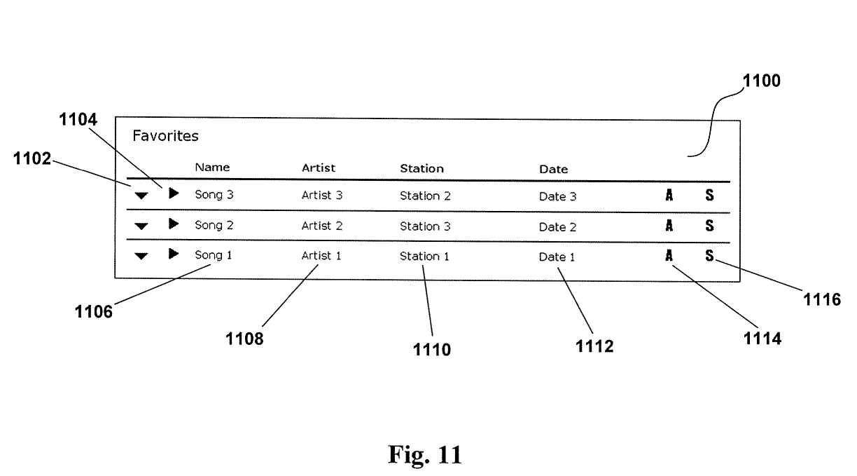

Content pop-up menu 800 further includes “Add to Favorites” menu choice 814. In one embodiment, “Add to Favorites” menu choice 814 enables the user to selectively associate the song or other content object with a favorites list. FIG. 11 depicts “Favorites” display 1100. “Favorites” display 1100 may appear, for example, as a panel in graphical user interface 208 or as a separate web page provided by playlist server 108. Another way for the user to access “Favorites” display 1100 is by selecting “Favorites” button 210 (FIG. 2a). “Favorites” display 1100 keeps track of songs that the user has identified as good or otherwise significant. In one embodiment, “Favorites” display 1100 features management icons 1102 and 1104, song text 1106, artist text 1108 and station text 1110. Management icons 1102 and 1104 enable the user to remove and otherwise manipulate songs listed in the favorites list in “Favorites” display 1100. Song text 1106 and artist text 1108 provide information about the song that has been selectively associated with the “Favorites” list. Station text 1110 provides the name of the station, such as the station corresponding to the “Station 1” button 308, from which the song was selectively associated with the “Favorites” list.

In one embodiment, “Favorites” display 1100 also features date 1112, album purchase icon 1114 and song purchase item 1116. Date 1112 provides information as to when the song was selectively associated with the “Favorites” list. Album purchase icon 1114 enables the selective purchase of the album (or other content object) from which the song originates. One way to enable the selective purchase of the album is to hyperlink album purchase icon 1114 to a web site such as the web site of Amazon.com, which sells albums. Song purchase icon 1116 enables the selective purchase of the song (or other content object). One way to enable the selective purchase of the song is to hyperlink song purchase icon 1116 to a web site such as the “iTunes” web site from Apple Computer Corp. that offers songs for sale.

It will be appreciated that the design of all displays, windows, interfaces, panels, graphic elements and other components discussed are not limited to the designs specified. Rather, such designs may be of any type or variety that is aesthetically pleasing or functional.

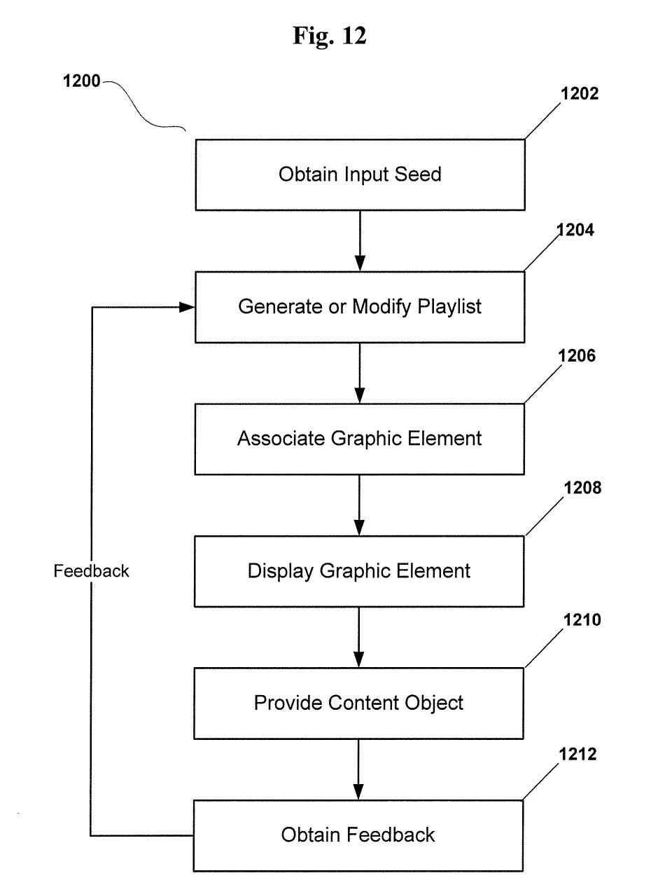

FIG. 12 depicts a flow diagram overview of a method for presenting and providing content to a user 1200 that can be executed in connection with, for example, the system depicted in FIG. 1.

In “Obtain Input Seed” step 1202 of FIG. 12, the user is enabled to selectively provide an input seed. As stated previously, the input seed may be a song name such as “Paint It Black” or even a group of songs such as “Paint It Black” and “Ruby Tuesday.” Alternatively, the input seed may be an artist name such as “Rolling Stones.” Other types of input seeds could include, for example, genre information such as “Classic Rock” or era information such as “1960s.” In one embodiment of the invention, the input seed is sent to playlist server 108 (FIG. 1) in order to perform the subsequent generation of a playlist. Encryption and other security methods may be used to protect communications between playlist server 108, content server 118 and/or terminals 102, 104 and 106.

In “Generate or Modify Playlist” step 1204, a playlist is first generated as a result of a comparison between the input seed and a plurality of database items. As stated previously, in one embodiment of the invention, the input seed is received from terminals 102, 104 and 106 and the playlist is generated on playlist server 108.

One or more embodiments of the invention utilize the “MUSIC GENOME PROJECT” database, which is a large database of records, each describing a single piece of music and an associated set of search and matching functions that operate on that database. The matching engine effectively calculates the distance between a source song and the other songs in the database and then sorts the results to yield an adjustable number of closest matches. Before continuing with FIG. 12, a method of generating or modifying a playlist will be discussed in accordance with one embodiment of the “MUSIC GENOME PROJECT” database will be discussed.

Song Matching

In the “MUSIC GENOME PROJECT” database, each song is described by a set of characteristics, or “genes”, or more that are collected into logical groups called “chromosomes.” The set of chromosomes make up the genome. One of these major groups in the genome is the “Music Analysis” Chromosome. This particular subset of the entire genome is sometimes referred to as “the genome.”

Each gene can be thought of as an orthogonal axis of a multi-dimensional space and each song as a point in that space. Songs that are geometrically close to one another are “good” musical matches. To maximize the effectiveness of the music matching engine, we maximize the effectiveness of this song distance calculation.

A given song “S” is represented by a vector containing approximately 150 genes. Each gene corresponds to a characteristic of the music, for example, gender of lead vocalist, level of distortion on the electric guitar, type of background vocals, etc. In a preferred embodiment, rock and pop songs have 150 genes, rap songs have 350, and jazz songs have approximately 400. Other genres of music, such as world and classical, have 300-500 genes. The system depends on a sufficient number of genes to render useful results. Each gene “s” of this vector has a value of an integer or half-integer between 0 and 5. However, the range of values for characteristics may vary and is not strictly limited to just integers or half-integers between 0 and 5.
Song S=(s₁, s₂, s₃, . . . , sₙ)

The simple distance between any two songs “S” and “T”, in n-dimensional space, can be calculated as follows:
distance=square-root of (the sum over all n elements of the genome of (the square of (the difference between the corresponding elements of the two songs)))

This can be written symbolically as:
distance(S, T)=sqrt [(for i=1 to n)Σ(sᵢ−tᵢ)ˆ2]

Because the monotonic square-root function is used in calculating all of these distances, computing the function is not necessary. Instead, the invention uses distance-squared calculations in song comparisons. Accepting this and applying subscript notation, the distance calculation is written in simplified form as:
distance(S, T)=Σ(s−t)ˆ2

Weighted and Focus Matching

Weighted Matching

Because not all of the genes are equally important in establishing a good match, the distance is better calculated as a sum that is weighted according to each gene's individual significance. Taking this into account, the revised distance can be calculated as follows:
distance=Σ[w*(s−t)ˆ2]=[w₁*(s₁−t₁)ˆ2]+[w₂*(s₂−t₂)ˆ2]+. . .

where the weighting vector “W.”
Song W=(w₁, w₂, w₃, . . . wₙ)
is initially established through empirical work done, for example, by a music team that analyzes songs. The weighting vector can be manipulated in various ways that affect the overall behavior of the matching engine. This will be discussed in more detail later in this document.

Scaling Functions

The data represented by many of the individual genes is not linear. In other words, the distance between the values of 1 and 2 is not necessarily the same as the distance between the values of 4 and 5. The introduction of scaling functions f(x) may adjust for this non-linearity. Adding these scaling functions changes the matching function to read:
distance=Σ[w*(f(s)−f(t))ˆ2]

There are a virtually limitless number of scaling functions that can be applied to the gene values to achieve the desired result.

Alternatively, one can generalize the difference-squared function to any function that operates of the absolute difference of two gene values. The general distance function is:
distance=Σ[w*g(|s−t|)]

In the specific case, g(x) is simply x², but it could become x³ for example if it was preferable to prioritize songs with many small differences over ones with a few large ones.

Focus Matching

Focus matching allows the end user of a system equipped with a matching engine to control the matching behavior of the system. Focus traits may be used to re-weight the song matching system and refine searches for matching songs to include or exclude the selected focus traits.

Focus Trait Presentation

Focus Traits are the distinguishing aspects of a song. When an end user enters a source song into the system, its genome is examined to determine which focus traits have been determined by music analysts to be present in the music. Triggering rules are applied to each of the possible focus traits to discover which apply to the song in question. These rules may trigger a focus trait when a given gene rises above a certain threshold, when a given gene is marked as a definer, or when a group of genes fits a specified set of criteria. The identified focus traits (or a subset) are presented on-screen to the user. This tells the user what elements of the selected song are significant.

Focus Trait Matching

An end user can choose to focus a match around any of the presented traits. When a trait, or number of traits, is selected, the matching engine modifies its weighting vector to more tightly match the selection. This is done by increasing the weights of the genes that are specific to the Focus Trait selected and by changing the values of specific genes that are relevant to the Trait. The resulting songs will closely resemble the source song in the trait(s) selected.

Personalization

The weighting vector can also be manipulated for each end user of the system. By raising the weights of genes that are important to the individual and reducing the weights of those that are not, the matching process can be made to improve with each use.

Aggregation

Song to Song Matching

The matching engine is capable of matching songs. That is, given a source song, it can find the set of songs that closely match it by calculating the distances to all known songs and then returning the nearest few. The distance between any two songs is calculated as the weighted Pythagorean sum of the squares of the differences between the corresponding genes of the songs.

Basic Multi-Song Matching

It may also be desirable to build functionality that will return the best matches to a group of source songs. Finding matches to a group of source songs is useful in a number of areas as this group can represent a number of different desirable searches. The source group could represent the collected works of a single artist, the songs on a given CD, the songs that a given end user likes, or analyzed songs that are known to be similar to an unanalyzed song of interest. Depending on the makeup of the group of songs, the match result has a different meaning to the end user but the underlying calculation should be the same.

This functionality provides a list of songs that are similar to the repertoire of an artist or CD. Finally, it will allow us to generate recommendations for an end user, purely on taste, without the need for a starting song.

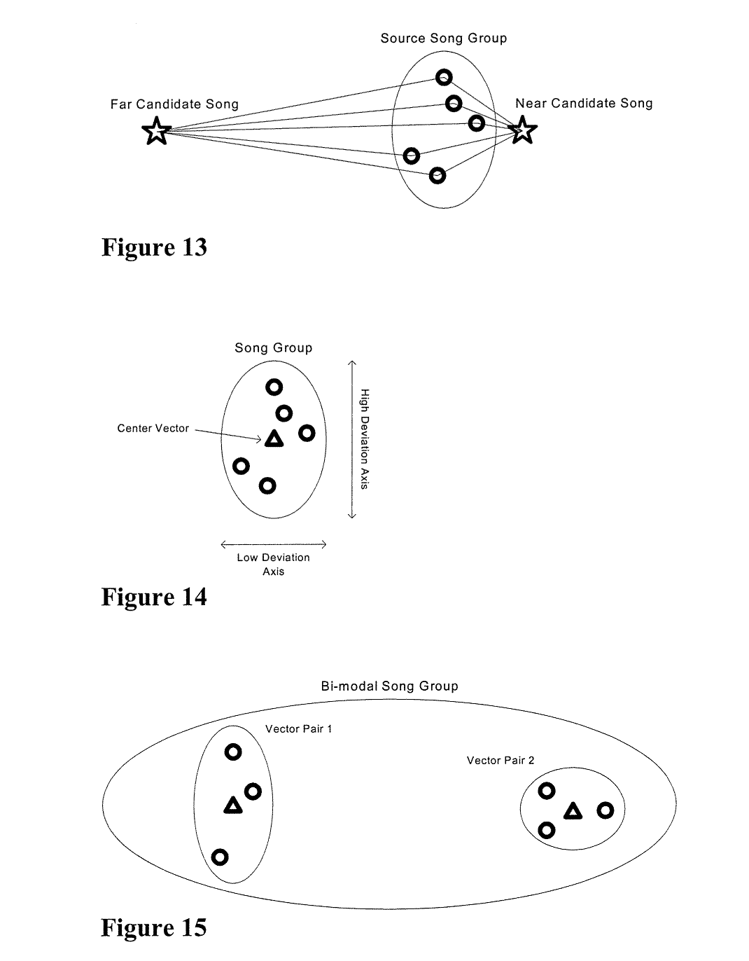

FIG. 13 illustrates two songs. In this Figure, the song on the right is a better match to the set of source songs in the center.

Vector Pairs

Referring to FIG. 14, one way to implement the required calculation is to group the songs into a single virtual song that can represent the set of songs in calculations. The virtual “center” is defined to be a song vector whose genes are the arithmetic average of the songs in the original set. Associated with this center vector is a “deviation” vector that represents the distribution of the songs within the set. An individual gene that has a very narrow distribution of values around the average will have a strong affinity for the center value. A gene with a wide distribution, on the other hand, will have a weak affinity for the center value. The deviation vector will be used to modify the weighing vector used in song-to-song distance calculations. A small deviation around the center means a higher net weighting value.

The center-deviation vector pair can be used in place of the full set of songs for the purpose of calculating distances to other objects.

Raw Multi-Song Matching Calculation

If the assumption is made that a songs gene's are normally distributed and that they are of equal importance, the problem is straightforward. First a center vector is calculated and a standard deviation vector is calculated for the set of source songs. Then the standard song matching method is applied, but using the center vector in place of the source song and the inverse of the square of the standard deviation vector elements as the weights:
Target song vectors T=(t₁, t₂, . . . tₙ)
Center vector of the source group C=(μ₁, μ₂, . . . μₙ)
Standard deviation vector of the source group D=(σ₁, σ₂, . . . σₙ)
distances=Σ[(1/σᵢ)ˆ2*(μᵢ−tᵢ)ˆ2]

As is the case with simple song-to-song matching, the songs that are the smallest distances away are the best matches.

Using Multi-Song Matching With the Weighting Vector

The weighting vector that has been used in song-to-song matching must be incorporated into this system alongside the 1/σˆ2 terms. Assuming that they are multiplied together so that the new weight vector elements are simply:
New weight=wᵢ/σᵢˆ2

A problem that arises with this formula is that when σ² is zero the new weight becomes infinitely large. Because there is some noise in the rated gene values, σ² can be thought of as never truly being equal to zero. For this reason a minimum value is added to it in order to take this variation into account. The revised distance function becomes:
distanceₜ=Σ[(wᵢ*0.25/(σᵢˆ2+0.25))*(μᵢ−tᵢ)ˆ2]

Other weighting vectors may be appropriate for multi-song matching of this sort. Different multi-song weighting vector may be established, or the (0.5)² constant may be modified to fit with empirically observed matching results.

Taste Portraits

Groups with a coherent, consistent set of tracks will have both a known center vector and a tightly defined deviation vector. This simple vector pair scheme will breakdown, however, when there are several centers of musical style within the collection. In this case we need to describe the set of songs as a set of two or more vector pairs.

As shown in FIG. 15, the song group can be described with two vector pairs. By matching songs to one OR the other of the vector pairs, we will be able to locate songs that fit well with the set. If we were to try to force all of the songs to be described by a single pair, we would return songs in the center of the large ellipse that would not be well matched to either cluster of songs.

Ideally there will be a small number of such clusters, each with a large number of closely packed elements. We can then choose to match to a single cluster at a time. In applications where we are permitted several matching results, we can choose to return a few from each cluster according to cluster size.

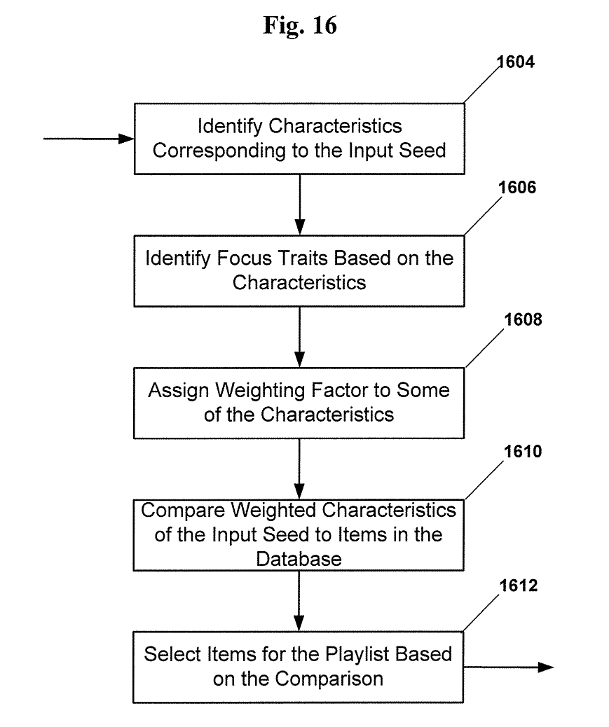

Returning to “Generate or Modify Playlist” step 1204 in FIG. 12, FIG. 16 shows a more detailed flow diagram for one or more embodiments of this step.

In “Identify Characteristics” step 1604 in FIG. 16, characteristics that correspond to the input seed are identified. As stated previously, characteristics may include, for example, gender of lead vocalist, level of distortion on the electric guitar, type of background vocals, etc. Characteristics may also include, for example, other types of musicological attributes such as syncopation, which is a shift of accent in a musical piece that occurs when a normally weak beat is stressed. In one or more embodiments of the invention, such characteristics are retrieved from one or more items corresponding to the input seed in a Music Genome Project database.

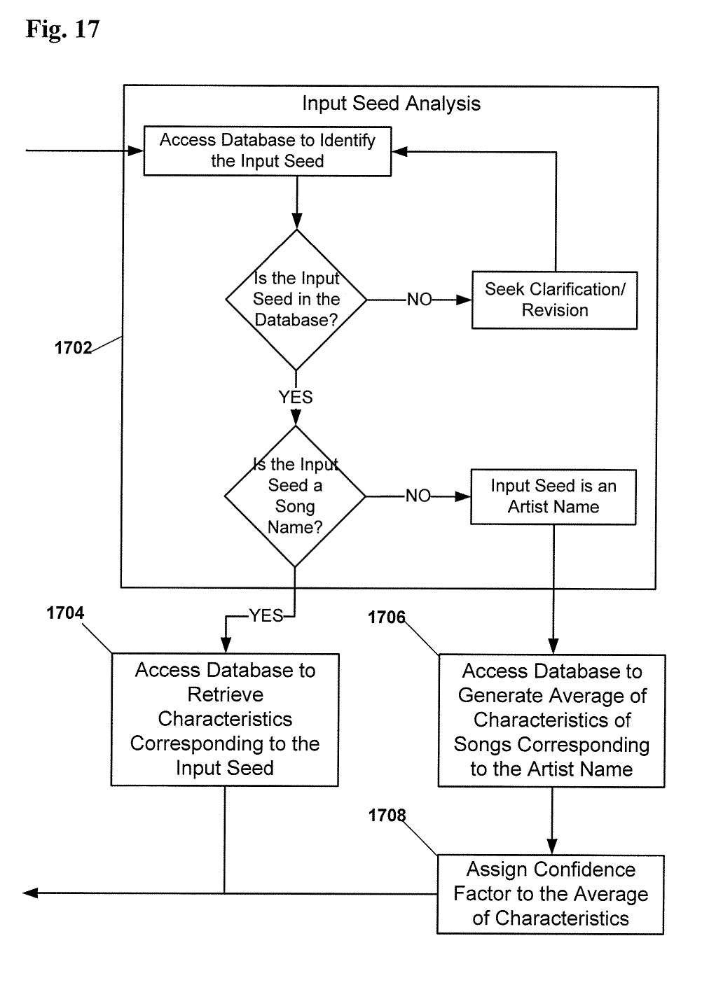

FIG. 17 shows a more detailed flow diagram for one embodiment of the “Identify Characteristics” step 1604 (FIG. 16). As indicated previously, “Identify Characteristics” step 1604 as well as all of the other steps in FIG. 16, can be executed on, for example, the servers in FIG. 1.

In order to identify characteristics corresponding to the input seed, the input seed itself must first be analyzed as shown in “Input Seed Analysis” step 1702. Accordingly, database 112 in FIG. 1, which may be a Music Genome Project database, is accessed to first identify whether the input seed is an item in database 112. To the extent the input seed is not an item in the database, the user may be asked for more information in an attempt to determine, for example, whether the input seed was inputted wrong (e.g., “Beetles” instead of “Beatles”) or whether the input seed goes by another name in database (e.g., “I feel fine” instead of “She's in love with me”). Alternatively, close matches to the input seed may be retrieved from the database and displayed to the user for selection.

If the input seed is in the database, the input seed is then categorized. In the embodiment shown in FIG. 17, the input seed is categorized as either a “Song Name” or “Artist Name.” Such categorization is realized by, for example, retrieving “Song Name” or “Artist Name” information associated with the input seed from the database. Alternatively, such categorization is realized by asking the user whether the input seed is a “Song Name” or “Artist Name.”

If the input seed is a song name, then “Retrieve Characteristics” step 1704 is executed. In “Retrieve Characteristics” step 1704, a song vector “S” that corresponds to the song is retrieved from the database for later comparison to another song vector. As stated previously, in one embodiment the song vector contains approximately 150 characteristics, and may have 400 or more characteristics:
Song S=(s₁, s₂, s₃, . . . , sₙ)

Each characteristic “s” of this vector has a value selected from a range of values established for that particular characteristic. For example, the value of the “syncopation” characteristic may be any integer or half-integer between 0 and 5. As an empirical example, the value of the syncopation characteristic for most “Pink Floyd” songs is 2 or 2.5. The range of values for characteristics may vary and is not limited to just integers or half-integers between 0 and 5.

If the input seed is an artist name, then (in the embodiment of FIG. 17) “Generate Average” step 1706 is executed. In one embodiment of “Generate Average” step 1706, song vectors S₁ to Sₙ, which each correspond to one of n songs in the database by the artist that is the subject of the input seed, are retrieved. Alternatively, and as stated previously, song vectors S₁ to Sₙ could correspond to one of n songs in the database on a particular album by the artist.

After song vectors S₁ to Sₙ have been retrieved, an average of all values for each characteristic of every song vector S₁ to Sₙ is calculated and populated into a “center” or virtual song vector:
Center vector C=(μ₁, μ₂, . . . μₙ)
μ₁=(s_{1,1}+s_{2,1}+. . . s_{n,1})/n

Of course, other statistical methods besides computing an average could be used to populate center vector “C.” Center vector “C” is then used for later comparison to another song vector as a representation of, for example, the average of all songs by the artist. In one embodiment of the invention, center vector “C₁” corresponding to a first artist may be compared to center vector “C₂” corresponding to a second artist.

After song vectors S₁ to Sₙ have been retrieved, “assign confidence factor” step 1708 is executed. In “assign confidence factor” step 1708, a deviation vector “D” is calculated:
Deviation Vector D=(σ₁, σ₂, . . . σₙ)
σ₁=sqrt(((s_{1,1}−μ₁)ˆ2+(s_{2,1}−μ₁)ˆ2+(s_{n,1}−μ₁)ˆ2)/(n−1))

that shows how similar or dissimilar are the characteristics among each of song vectors S₁ to Sₙ. While one embodiment of the invention contemplates populating the deviation vector by determining the standard deviation of all values for each characteristic of every song vector S₁ to Sₙ, other statistical methods could also be used. As an empirical example of the use of standard deviation to calculate the deviation vector, the value of the syncopation characteristic for most “Pink Floyd” songs is 2 or 2.5, which results in a smaller standard deviation value (e.g., 0.035) than if a standard deviation value were calculated for a characteristic having more divergent values (e.g., if the value of the syncopation characteristic for all songs by Pink Floyd was more widely dispersed between 0 and 5).

To the extent a standard deviation value for a certain characteristic is larger, the averaged value of that characteristic in the virtual song vector is considered to be a less reliable indicator of similarity when the virtual song vector is compared to another song vector. Accordingly, as indicated previously, the values of the deviation vector serve as “confidence factors” that emphasize values in the virtual song vector depending on their respective reliabilities. One way to implement the confidence factor is by multiplying the result of a comparison between the center vector and another song vector by the inverse of the standard deviation value. Thus, for example, the confidence factor could have a value of 0.25/(σᵢˆ2+0.25). The “0.25” is put into the equation to avoid a mathematically undefined result in the event σᵢˆ2 is 0 (i.e., the confidence factor avoids “divide by zero” situations).

Returning to FIG. 16, “Identify Focus Traits” step 1606 identifies focus traits based on the values of characteristics of song vector (or virtual song vector) S. As stated previously, focus traits are specific combinations of characteristics (or even a single notable characteristic) representing significantly discernable attributes of a song. As such, focus traits are the kernel of what makes one song actually sound different, or like, another song. Focus traits may be created and defined in many ways, including by having trained musicologists determine what actually makes one song sound different from another, or else having users identify personal preferences (e.g., receiving input from a user stating that he/she likes songs with male lead vocals). Exemplary focus traits include “male lead vocal” or “Middle Eastern influence.” There can be 1, 10, 1000 or more than 1000 focus traits, depending on the desired complexity of the system.

In one embodiment of the invention, a set of rules known as “triggers” is applied to certain characteristics of song vector S to identify focus traits. For example, the trigger for the focus trait “male lead vocal” may require the characteristic “lead vocal present in song” to have a value of 5 on a scale of 0 to 5, and the characteristic “gender” to also have a value of 5 on a scale of 0 to 5 (where “0” is female and “5” is male). If both characteristic values are 5, then the “male lead vocal” focus trait is identified. This process is repeated for each focus trait. Thereafter, any identified focus traits may be presented to the user through the user interface.

Now that focus traits have been identified, “Weighting Factor Assignment” step 1608 is executed. In “weighting factor assignment” step 1608, comparative emphasis is placed on some or all of focus traits by assigning “weighting factors” to characteristics that triggered the focus traits. Alternatively, “weighting factors” could be applied directly to certain characteristics.

Accordingly, musicological attributes that actually make one song sound different from another are “weighted” such that a comparison with another song having those same or similar values of characteristics will produce a “closer” match. In one embodiment of the invention, weighting factors are assigned based on a focus trait weighting vector W, where w₁, w₂ and wₙ, correspond to characteristics s₁, s₂ and sₙ of song vector S.
Weighting Vector W=(w₁, w₂, w₃, . . . wₙ)

In one embodiment of the invention, weighting vector W can be implemented into the comparison of songs having and song vectors “S” and “T” by the following formula:
distance (W, S, T)=Σw*(s−t)ˆ2

As described previously, one way to calculate weighting factors is through scaling functions. For example, assume as before that the trigger for the focus trait “male lead vocal” requires the characteristic “lead vocal present in song” to have a value of 5 on a scale of 0 to 5, and the characteristic “gender” to also have a value of 5 on a scale of 0 to 5 (where “0” is female and “5” is male).

Now assume the song “Yesterday” by the Beatles corresponds to song vector S and has an s₁ value of 5 for the characteristic “lead vocal present in song” and an s₂ value of 5 for the characteristic “gender.” According to the exemplary trigger rules discussed previously, “Yesterday” would trigger the focus trait “male lead vocal.” By contrast, assume the song “Respect” by Aretha Franklin corresponds to song vector T and has a t₁ value of 5 for the characteristic “lead vocal present in song” and a t₂ value of 0 for the characteristic “gender.” These values do not trigger the focus trait “male lead vocal” because the value of the characteristic “gender” is 0. Because a focus trait has been identified for characteristics corresponding to s₁ and s₂, weighting vector W is populated with weighting factors of, for example, 100 for w₁ and w₂. Alternatively, weighting vector W could receive different weighting factors for w₁ and w₂ (e.g., 10 and 1000, respectively).

In “Compare Weighted Characteristics” step 1610, the actual comparison of song vector (or center vector) S is made to another song vector T. Applying a comparison formula without a weighting factor, such as the formula distance(S, T)=(s−t)ˆ2, song vectors S and T would have a distance value of (s₁−t₁)ˆ2+(s₂−t₂)ˆ2, which is (5−5)ˆ2+(5−0)ˆ2, or 25. In one embodiment of the invention, a distance value of 25 indicates a close match.

By contrast, applying a comparison formula featuring weighting vector W produces a different result. Specifically, the weighting vector W may multiply every difference in characteristics that trigger a particular focus trait by 100. Accordingly the equation becomes w₁(s₁−t₁)ˆ2+w₂(s₂−t₂)ˆ2, which is 100(5−5)ˆ2+100(5−0)ˆ2, or 2500. The distance of 2500 is much further away than 25 and skews the result such that songs having a different gender of the lead vocalist are much less likely to match. By contrast, if song vector T corresponded to another song that did trigger the focus trait “male lead vocal” (e.g., it is “All I Want Is You” by U2), then the equation becomes 100(5−5)ˆ2+100(5−5)ˆ2, or 0, indicating a very close match.

As another example of one embodiment of the invention, a weighting vector value of 1,000,000 in this circumstance would effectively eviscerate any other unweighted matches of characteristics and means that, in most circumstances, two songs would never turn up as being similar.

As indicated previously, it is also possible for one or more values of the weighting vector to be assigned based on preferences of the user. Thus, for example, a user could identify a “male lead vocal” as being the single-most important aspect of songs that he/she prefers. In doing so, a weighting vector value of 10,000 may be applied to the comparison of the characteristics associated with the “'male lead vocal” focus trait. As before, doing so in one embodiment of the invention will drown out other comparisons.

In one embodiment of the invention, one weighting vector is calculated for each focus trait identified in a song. For example, if 10 focus traits are identified in a song (e.g., “male lead vocalist” and 9 other focus traits), then 10 weighting vectors are calculated. Each of the 10 weighting vectors is stored for potential use during “Compare Weighted Characteristics” step 1610. In one embodiment of the invention, users can select which focus traits are important to them and only weighting vectors corresponding to those focus traits will be used during “Compare Weighted Characteristics” step 1610. Alternatively, weighting vectors themselves could be weighted to more precisely match songs and generate playlists.

In “Select Items” step 1612, the closest songs are selected for the playlist based on the comparison performed in “Compare Weighted Characteristics” step 1610. In one embodiment of the invention, the 20 “closest” songs are preliminary selected for the playlist and placed into a playlist set. Individual songs are then chosen for the playlist. One way to choose songs for the playlist is by random selection. For example, 3 of the 20 songs can be randomly chosen from the set. In one embodiment of the invention, another song by the same artist as the input seed is selected for the playlist before any other songs are chosen from the playlist. One way to do so is to limit the universe of songs in the database to only songs by a particular artist and then to execute the playlist generating method.

To the extent a set of weighted song vectors was obtained, a plurality of sets of closest songs are obtained. For example, if a song has 10 focus traits and the 20 closest songs are preliminarily selected for the playlist, then 10 different sets of 20 songs each (200 songs total) will be preliminarily selected. Songs can be selected for the playlist from each of the sets by, for example, random selection. Alternatively, each set can have songs be selected for the playlist in order corresponding to the significance of a particular focus trait.

As an alternative, or in addition to, randomly selecting songs for the playlist, rules may be implemented to govern the selection behavior. For example, aesthetic criteria may be established to prevent the same artist's songs from being played back-to-back after the first two songs, or to prevent song repetition within 4 hours.

Moreover, regulatory criteria may be established to comply with, for example, copyright license agreements (e.g., to prevent the same artist's songs from being played more than 4 times in 3 hours). To implement such criteria, a history of songs that have been played may be stored along with the time such songs were played.

Accordingly, songs are selected for the playlist from one or more playlist sets according to random selection, aesthetic criteria and/or regulatory criteria. To discern the actual order of songs in the playlist, focus traits can be ranked (e.g., start with all selected songs from the playlist set deriving from the “male lead vocal” focus trait and then move to the next focus trait). Alternatively, or in addition, the user can emphasize or de-emphasize particular playlist sets. If, for example, a user decides that he/she does not like songs having the focus trait of “male lead vocal,” songs in that playlist set can be limited in the playlist.

A number of songs are selected from the Set List and played in sequence as a Set. Selection is random, but limited to satisfy aesthetic and business interests, (e.g. play duration of a particular range of minutes, limits on the number of repetitions of a particular Song or performing artist within a time interval). A typical Set of music might consist of 3 to 5 Songs, playing for 10 to 20 minutes, with sets further limited such that there are no song repetitions within 4 hours and no more than 4 artist repetitions within 3 hours.

In one embodiment of the invention, the playlist features identifiers that correspond to, for example, song names. The identifiers may be index fields or other handles for content database 120 on content server 118. After the playlist has been generated, playlist server 108 may send an identifier corresponding to the input seed to the user at terminal 102, 104 or 106. To the extent the input seed was an artist name requiring the creation of a “center vector,” playlist server 108 may, for example, send an identifier corresponding to a song that is the closest match to the “center vector.” In one embodiment of the invention, a set of identifiers may be sent to terminal 102, 104 or 106 (or to multiple terminals) at once.

After an identifier is remotely provided to terminal 102, 104 or 106, the player on terminal 102, 104 or 106 proceeds to associate a graphic element (such as first graphic element 314 in FIG. 3) with the identifier. For example, content server 118 may store song name 316, artist name 318 and content art 320 in connection with a corresponding content object in content database 120. Accordingly, the player on terminal 102, 104 or 106 may request song name 316, artist name 318 and content art 320 that corresponds to the input seed or identifier from content server 118. Content server 118 then provides, in encrypted form, song name 316, artist name 318 and content art 320 to the player on terminal 102, 104 or 106.

In “Display Graphic Element” step 1208, first graphic element 314 appears in graphical user interface 208 as discussed previously. Song name 316, artist name 318 and content art 320 may be provided within first graphic element 314.

In “Provide Content Object” step 1210, a content object corresponding to the identifier or input seed is provided. For example, the player in terminal 102, 104 or 106 may send the identifier received from playlist server 108 to content server 118. In response, content server 118 may provide a content object corresponding to the identifier to the player on terminal 102, 104 or 106 and thus to the user.

Content server 118 may provide a content object to the user in several ways. For example, content server 118 may stream content object to the user through well-known streaming techniques and protocols such as User Datagram Protocol (UDP), Real Time Transport Protocol (RTP), Real Time Streaming Protocol (RTSP), Real Time Control Protocol (RTCP) and Transmission Control Protocol (TCP). As another example, content server 118 may provide a content object to the user through downloading. Thus, the content object is downloaded fully to terminal 102, 104 or 106 before it is provided to the user. As yet another example, the content object may be provided to the user through a hybrid method of streaming and downloading. In an embodiment of the invention, content server 118 may provide a content object at a rate of 10 to 20 times that of the playback rate. Portions of the content object that have not been played are cached in memory on terminal 102, 104 or 106.

In “Provide Content Object” step 1210, a content object corresponding to the identifier or input seed is provided. For example, the player in terminal 102, 104 or 106 may send the identifier received from playlist server 108 to content server 118. In response, content server 118 may provide a content object corresponding to the identifier to the player on terminal 102, 104 or 106 and thus to the user.

In “Obtain Feedback” step 1212, the user selectively provides feedback about a content object through graphical user interface 208 in the manner discussed previously. In one embodiment of the invention, feedback that has been selectively provided by the user is sent to playlist server 108. If the feedback about a content object is negative, then the playlist may be modified as discussed previously. For example, the user may selectively provide feedback that is negative about a song with a focus trait of “male lead vocal.” In response, a new playlist is generated by playlist server 108 (i.e., the existing playlist is modified) that accounts for the negative feedback. In one embodiment of the invention, a weighting value or scaling function corresponding to the focus trait of “male lead vocal” may be adjusted such that songs having strong focus traits of “male lead vocal” are less likely to match with the input seed originally provided by the user.

As another example, the user may selectively provide feedback that he or she does not like “jazz” music. “Jazz” may be a characteristic stored with regard to various songs in database 112. A weighting value of 1/1,000,000,000 is then assigned to the characteristic “jazz,” which means that a match between the input seed and “jazz” songs is unlikely to result from a comparison of the input seed and database items. Accordingly, the playlist will be modified to remove jazz songs.

The invention has been described with respect to specific examples including presently preferred modes of carrying out the invention. Those skilled in the art will appreciate that there are numerous variations and permutations of the above described systems and techniques, for example, that would be used with videos, wine, films, books and video games, that fall within the spirit and scope of the invention as set forth in the appended claims.

We claim:

1. A method of presenting content to a user, comprising:
enabling the user to selectively provide an input seed corresponding to one or more database items;
generating a playlist as a result of a comparison between the input seed and a plurality of database items, the playlist having an identifier corresponding to one of the plurality of database items;
associating a first graphic element with the input seed;
representing the first graphic element on a display;
associating a second graphic element with the identifier; and
representing the second graphic element on the display.

2. The method of claim 1 wherein the input seed is a song name or artist name.

3. The method of claim 1 wherein the step of enabling the user to selectively provide an input seed further includes disambiguating the input seed.

4. The method of claim 1, further comprising enabling the user to customize the display of the first graphical element.

5. The method of claim 1, further comprising enabling the user to selectively provide the playlist to another user.

6. The method of claim 1, further comprising enabling the user to selectively modify the input seed.

7. The method of claim 1, further comprising providing to the user a content object corresponding to the identifier.

8. The method of claim 7, further comprising selectively providing information about the content object to the user, wherein the information relates to a characteristic or focus trait.

9. The method of claim 7, further comprising enabling the user to selectively purchase the content object.

10. The method of claim 7, further comprising enabling the user to selectively provide feedback about the content object.

11. The method of claim 7, further comprising enabling the user to selectively modify feedback about the content object.

12. The method of claim 7, further comprising enabling the user to selectively associate the content object with a favorites list.

13. A method of providing content to a user, comprising:
generating a playlist as a result of a comparison of a plurality of database items, the playlist having a first identifier corresponding to a first database item and a second identifier corresponding to a second database item;
associating a first graphic element with the first identifier;
representing the first graphic element on a display; and
providing to the user a first content object corresponding to the first identifier.

14. The method of claim 13, further comprising selectively providing information about the first content object to the user.

15. The method of claim 14, wherein the information relates to a characteristic or focus trait.

16. The method of claim 14, wherein the information is background knowledge.

17. The method of claim 13, further comprising enabling the user to selectively purchase the first content object.

18. The method of claim 13, further comprising enabling the user to selectively provide feedback about the first content object.

19. The method of claim 13, further comprising enabling the user to selectively associate the first content object with a favorites list.

20. The method of claim 13, further comprising:
associating a second graphic element with the second identifier;
representing the second graphic element on the display; and
providing to the user a second content object corresponding to the second identifier.

21. The method of claim 20, wherein the step of representing the second graphic element on the display does not occur until after the step of providing the first content object.

22. The method of claim 20, further comprising:
enabling the user to selectively provide feedback about the first content object; and
enabling the user to selectively provide feedback about the second content object.

23. A computer-readable medium having computer-executable instructions for performing steps comprising:
generating a playlist as a result of a comparison of a plurality of database items, the playlist having a first identifier corresponding to a first database item and a second identifier corresponding to a second database item;
associating a first graphic element with the first identifier;
representing the first graphic element on a display; and
providing to the user a first content object corresponding to the first identifier.

24. The computer-readable medium of claim 23, further comprising the step of selectively providing information about the first content object to the user.

25. The computer-readable medium of claim 23, further comprising the step of enabling the user to selectively purchase the first content object.

26. The computer-readable medium of claim 23, further comprising the step of enabling the user to selectively provide feedback about the first content object.

27. The computer-readable medium of claim 23 further comprising the steps of:
associating a second graphic element with the second identifier;
representing the second graphic element on the display; and
providing to the user a second content object corresponding to the second identifier.

28. The computer-readable medium of claim 24 wherein the step of representing the second graphic element on the display does not occur until after the step of providing the first content object.

29. The computer-readable medium of claim 23, further comprising the steps of:
enabling the user to selectively provide feedback about the first content object; and
enabling the user to selectively provide feedback about the second content object.

30. A method of presenting content to a user, comprising:
enabling a user to selectively provide an input seed corresponding to one or more database items;
generating a playlist as a result of a comparison between the input seed and a plurality of database items;
associating a first graphic element with the input seed;
representing the first graphic element on a display;
providing to the user a content object corresponding to the input seed;
enabling the user to selectively provide feedback about the content object; and
modifying the playlist in response to feedback provided by the user.

31. The method of claim 30 wherein the input seed is a song name or artist name.

32. The method of claim 30 wherein the feedback is positive or negative feedback.

33. The method of claim 30, further comprising enabling the user to selectively modify feedback about the content object.

34. The method of claim 30 wherein the feedback comprises reasons why the user likes or dislikes the content object.

35. The method of claim 30, further comprising selectively providing information about the content object to the user, wherein the information relates to a characteristic or focus trait.

36. The method of claim 30, further comprising enabling the user to selectively modify the input seed.

37. The method of claim 30, further comprising enabling the user to selectively purchase the content object.

38. The method of claim 30, further comprising enabling the user to selectively associate the content object with a favorites list.
